(19) United States
(12) Patent Application Publication
(10) Pub. No.: US 2012/0097187 A1
(43) Pub. Date: Apr. 26, 2012

(54) CLEANING APPARATUS, RADIATION SOURCE MODULE AND FLUID TREATMENT SYSTEM

(75) Inventors: Douglas Penhale, London (CA); Joseph Elku, Tillsonburg (CA); Ryan Moffatt, St. Tomas (CA); George Traubenberg, London (CA)

(73) Assignee: Trojan Technologies, London, ON (CA)

(21) Appl. No.: 13/256,419

(22) PCT Filed: Mar. 5, 2010
(86) PCT No.: PCT/CA2010/000311

§ 371 Date: Dec. 20, 2011

Related U.S. Application Data
(60) Provisional application No. 61/202,576, filed on Mar. 13, 2009.

(51) Int. Cl. B08B 1/00; B08B 9/38; B08B 3/00; B08B 7/00

(52) U.S. Cl. 134/6; 15/3; 15/93.1; 15/97.1; 137/561 R; 134/184

(57) ABSTRACT

There is disclosed a cleaning apparatus for a radiation source assembly in a fluid treatment system. The cleaning system comprises: a cleaning carriage comprising at least one cleaning element for contact with at least a portion of the exterior of the radiation source assembly; a rodless cylinder comprising an elongate housing having a first longitudinal axis; a slidable element disposed on an exterior surface of the elongate housing; and an elongate motive element coupled to the driving element. The slidable element is: (i) coupled to the cleaning carriage, and (ii) magnetically coupled to a driving element disposed within the elongate housing. The elongate motive element has a second longitudinal axis that is oriented in a substantially parallel, non-coaxial relationship with respect to the first longitudinal axis. There is also disclosed a fluid treatment system comprising: a fluid treatment zone for receiving a flow of fluid; at least one elongate radiation source assembly disposed in the fluid treatment zone; a cleaning apparatus having at least one cleaning element in contact with an exterior surface of the at least one elongate radiation source assembly; and a motive element coupled to the cleaning system. The elongate radiation source assembly has a longitudinal axis disposed transverse to a direction of fluid flow through the fluid treatment zone and a distal end of the at least one elongate radiation source assembly is spaced from a surface of the fluid treatment zone to define a gap. The motive element is operable to move the cleaning system between a retracted position and an extended position. Movement of the cleaning system from the retracted position to the extended position cause debris contacting the at least one elongate radiation source assembly to be pushed into the gap.

### CROSS-REFERENCE TO RELATED APPLICATION

The present application claims the benefit under 35 U.S.C. §119(e) of provisional patent application Ser. No. 61/202,576, filed Mar. 13, 2009, the contents of which are hereby incorporated by reference.

### FIELD OF THE INVENTION

In one of its aspects, the present invention relates to a fluid treatment system. In another of its aspects, the present invention relates to a cleaning apparatus. In yet another of its aspects, the present invention relates to a radiation source module containing the cleaning system. In another of its aspects, the present invention relates to a method of removing fouling materials from an exterior surface of a radiation source assembly. Other aspects of the invention will become apparent to those of skill in the art upon reviewing the present specification.

### DESCRIPTION OF THE PRIOR ART

Fluid treatment systems are known generally in the art.

For example, U.S. Pat. Nos. 4,482,809, 4,872,980 and 5,006,244 [all in the name of Maarschalkerweerd and hereinafter referred to as the Maarschalkerweerd #1 Patents] all describe gravity fed fluid treatment systems which employ ultraviolet (UV) radiation.

Such systems include an array of UV lamp frames which include several UV lamps each of which are mounted within sleeves which extend between and are supported by a pair of legs which are attached to a cross-piece. The so-supported sleeves (containing the UV lamps) are immersed into a fluid to be treated which is then irradiated as required. The amount of radiation to which the fluid is exposed is determined by the proximity of the fluid to the lamps, the output wattage of the lamps and the fluid's flow rate past the lamps. Typically, one or more UV sensors may be employed to monitor the UV output of the lamps and the fluid level is typically controlled, to some extent, downstream of the treatment device by means of level gates or the like.

Depending on the quality of the fluid which is being treated, the sleeves surrounding the UV lamps periodically become fouled with foreign materials, inhibiting their ability to transmit UV radiation to the fluid. For a given installation, the occurrence of such fouling may be determined from historical operating data or by measurements from the UV sensors. Once fouling has reached a certain point, the sleeves must be cleaned to remove the fouling materials and optimize system performance.

If the UV lamp modules are employed in an open, channel system (e.g., such as the one described and illustrated in Maarschalkerweerd #1 Patents), one or more of the modules may be removed while the system continues to operate, and the removed frames may be immersed in a bath of suitable cleaning solution (e.g., a mild acid) which may be air-agitated to remove fouling materials. This practice was regarded by many in the field as inefficient, labourious and inconvenient.

In many cases, once installed, one of the largest maintenance costs associated with prior art fluid treatment systems is often the cost of cleaning the sleeves about the radiation sources.

U.S. Pat. Nos. 5,418,370, 5,539,210 and RE36,896 [all in the name of Maarschalkerweerd and hereinafter referred to as the Maarschalkerweerd #2 Patents] all describe an improved cleaning system, particularly advantageous for use in gravity fed fluid treatment systems which employ UV radiation. Generally, the cleaning system comprises a cleaning carriage engaging a portion of the exterior of a radiation source assembly including a radiation source (e.g., a UV lamp). The cleaning carriage is movable between: (i) a retracted position wherein a first portion of radiation source assembly is exposed to a flow of fluid to be treated, and (ii) an extended position wherein the first portion of the radiation source assembly is completely or partially covered by the cleaning carriage. The cleaning carriage includes a chamber in contact with the first portion of the radiation source assembly. The chamber is supplied with a cleaning solution suitable for removing undesired materials from the first portion of the radiation source assembly.

The cleaning system described in the Maarschalkerweerd #2 Patents represented a significant advance in the art, especially when implemented in the radiation source module and fluid treatment system illustrated in these patents. However, implementation of the illustrated cleaning system in a fluid treatment module such as the one illustrated in the Maarschalkerweerd #1 Patents is problematic.

This problem was addressed by U.S. Pat. No. 6,342,188 [Pearcey et al. (Pearcey)]. Pearcey teaches the use of rodless cylinder as the driving mechanism for a cleaning system (e.g., the one taught by the Maarshalkerweerd #2 Patents or other cleaning systems). In the illustrated embodiments, Pearcey teaches the use of a hydraulic/pneumatic system (e.g, FIG. 6 of Pearcey) or a screw drive (FIG. 9 of Pearcey) to move a piston contained within the rodless cylinder. The piston is magnetically coupled to a slidable member on the exterior of the rodless cylinder. The slidable member is coupled to a cleaning carriage containing one or more cleaning rings. Thus, once the piston is moved within the rodless cylinder, the slidable member/cleaning carriage are correspondingly moved.

The hydraulic/pneumatic systems taught by Pearcey can be problematic. In the implementation of these systems a hydraulic pump or air compressor used centrally in the fluid treatment system was also used to drive the rodless cylinder. The pressurized feed was transferred to the rodless cylinder through the use of manifolds and tubing to the manifolds. Unfortunately, the tubing, the manifolds and their associated fittings tend to develop leaks over time causing a drop in pressure and, in the case of the hydraulic pump, an environmental concern from spilled hydraulic fluid. The pneumatic approach (use air compressors) is problematic since it does not provide a constant force to the rodless cylinder. Specifically, since air is compressible, pressure can build up if the system jams resulting in violent stops and starts of the cylinder during operation. Also, such hydraulic/pneumatic systems are relatively expensive to fabricate and service.

For these reasons, the screw drive system taught by Pearcey was investigated. The use of such a system generally overcame the above problems associated with the hydraulic/pneumatic systems. However, a different problem was raised. Specifically, in the implementation of the screw drive system taught by Pearcey, a coupling nut was used to engage the screw drive. When the coupling nut was used and the screw drive was actuated, the coupling nut would turn with the screw of the screw drive. If a key was used to secure the coupling nut, the key would need to be as long as the rodless cylinder—this was not a practical solution given the practical space constraints posed in the interior of the rodless cylinder. Pearcey also taught an enclosed screw drive such that it would not be exposed to debris, meaning that it would not be subject to binding and subsequent damage.

Accordingly, it would be desirable to have a solution to the problem associated with implementing the screw drive system taught by Pearcey.

In recent years, there has been interest in the so-called “transverse-to-flow” fluid treatment systems. In these systems, the radiation source is disposed in the fluid to be treated in a manner such that the longitudinal axis of the radiation source is in a transverse (e.g., orthogonal vertical orientation of the radiation sources) relationship with respect to the direction of fluid flow past the radiation source. See, for example, any one of:
International Publication Number WO 2004/000735 [Traubenberg et al.];
International Publication Number WO 2008/055344 [Ma et al.];
International Publication Number WO 2008/019490 [Traubenberg et al.];
U.S. Pat. No. 7,408,174 [From et al.]; and
U.S. provisional patent application Ser. No. 61/193,686 [Penhale et al.], filed Dec. 16, 2008.

When these fluid treatment systems have been implemented there is a problem of build-up of fouling materials on the exterior surface of the radiation sources. This is particularly a problem in the treatment of municipal waste water where such fouling materials have not been removed upstream of the UV disinfection system. The fouling material often takes the form of debris (e.g., hair, condoms, string, algae and other string-like material) which catches on the exterior surface of the radiation sources and remains there. Failure to adequately remove such fouling material leads to a number of problems, including one or more of the following:
reduced radiation dose delivered to the flow of fluid;
promotion of build-up of more fouling material;
increased hydraulic head loss of the flow fluid passes through the fluid treatment zone;
increased pressure/stress on a radiation source assembly; and
potential damage to equipment.
   To the knowledge of the present inventors, there are no known fluid treatment systems that including a cleaning system capable of adequately and reliably removing such fouling material from the exterior surface of the radiation sources during operation of the system (i.e., without the need to cease operation of the system to remove the fouling material).

Accordingly, it would be desirable to have a fluid treatment system capable of removing such fouling material during operation of the system.

### SUMMARY OF THE INVENTION

It is an object of the present invention to obviate or mitigate at least one of the above-mentioned disadvantages of the prior art.

It is another object of the present invention to provide a novel cleaning apparatus for a radiation source assembly in a fluid treatment system.

It is another object of the present invention to provide a novel fluid treatment system.

Accordingly, in one of its aspects, the present invention provides a cleaning apparatus for a radiation source assembly in a fluid treatment system, the cleaning system comprising:

a cleaning carriage comprising at least one cleaning element for contact with at least a portion of the exterior of the radiation source assembly;

a rodless cylinder comprising an elongate housing having a first longitudinal axis;

a slidable element disposed on an exterior surface of the elongate housing, the slidable element being: (i) coupled to the cleaning carriage, and (ii) magnetically coupled to a driving element disposed within the elongate housing; and

an elongate motive element coupled to the driving element, the elongate motive element having a second longitudinal axis that is oriented in a substantially parallel, non-coaxial relationship with respect to the first longitudinal axis.

The invention also relates to a radiation source module and to a fluid treatment system incorporating this cleaning apparatus.

Thus, in another of its aspects, the present invention provides a radiation source module for use in a fluid treatment system, the module comprising:

a frame having a first support member;

at least one radiation source assembly extending from the first support member, at least one radiation source assembly comprising a radiation source; and

the present cleaning system, the cleaning element of the cleaning carriage being in contact with at least a portion of an exterior of the at least one radiation source assembly.

Thus, in yet another of its aspects, the present invention provides a fluid treatment system comprising a fluid treatment zone for receiving a flow of fluid and at least one radiation source module defined above, wherein the at least one radiation source module is configured such that the one radiation source assembly is disposed in the fluid treatment zone.

In another of its aspects, the present invention provides a fluid treatment system comprising:

a fluid treatment zone for receiving a flow of fluid;

at least one elongate radiation source assembly disposed in the fluid treatment zone, the elongate radiation source assembly having a longitudinal axis disposed transverse to a direction of fluid flow through the fluid treatment zone, a distal end of the at least one elongate radiation source assembly being spaced from a surface of the fluid treatment zone to define a gap;

a cleaning apparatus having at least one cleaning element in contact with an exterior surface of the at least one elongate radiation source assembly; and

a motive element coupled to the cleaning system, the motive element operable to move the cleaning system between a retracted position and an extended position, wherein movement of the cleaning system from the retracted position to the extend position cause debris contacting the at least one elongate radiation source assembly to be pushed into the gap.

In yet another of its aspects, the present invention relates to a method for removing fouling material from an exterior surface of at least one radiation source assembly in a fluid treatment system as defined in the immediately preceding paragraph comprising the steps of:

translating the cleaning apparatus from the retracted position toward the extended position to cause fouling material disposed on the exterior surface of the at least one radiation source assembly to be translated toward the distal end; and

further translating the cleaning apparatus to the extended position to cause fouling material to be moved past the distal end of the at least one radiation source assembly into the gap.

Thus, in one of its aspects, the present invention relates to a fluid treatment system. The fluid treatment system consists of elongate radiation source assemblies having a longitudinal axis that is transverse to a direction of fluid flow through a fluid treatment zone in which the radiation source assemblies are disposed. The radiation source assemblies are disposed in a manner such that their distal tips are raised above the nearest surface of the fluid treatment zone (in most practical implementations of the open channel embodiment of the present fluid treatment system, this “nearest surface” is the bottom of the channel or channel floor). In a practical implementation of the present fluid treatment system, fluid treatment zone is in the open channel which receives a flow of fluid. The open channel has a bottom or floor surface above which is spaced the radiation source assemblies. By creating such a space or gap, it is then possible to remove fouling materials which are on the radiation source assemblies by translating a cleaning system along the exterior of the radiation source assemblies. This effectively pushes the fouling material (typically string-like debris as discussed above) towards the distal end of the radiation source assemblies. Once the cleaning system reaches its extended position, the fouling materials are simply pushed off the end of the radiation source assemblies and are carried away by the flow of fluid. Thus, cleaning of the radiation source assemblies can be affected during operation of the fluid treatment system without the need to shut down the system for maintenance purposes.

In a preferred embodiment of this aspect of the present invention, a baffle element is placed upstream of the radiation sources assemblies to mitigate or obviate shortcuiting of fluid travelling through the fluid treatment zone of the fluid treatment system. As is known in the art, “short-circuiting” occurs when fluid travels through the treatment zone at a distance greater than the maximum distance from the radiation source assemblies within which an effective radiation dose is delivered to fluid to achieve a pre-determined disinfection level of microorganisms contained in the fluid. Preferably, the baffle element has a height that corresponds substantially to at least the height of the gap between distal tip of the radiation source assemblies and the nearest surface of the fluid treatment zone (i.e., the “gap” referred to above). More preferably, the baffle element has a height that is greater than the height of the gap between distal tip of the radiation source assemblies and the nearest surface of the fluid treatment zone (i.e., the “gap” referred to above). In one embodiment, the baffle element is a fixed (i.e., static) element. In another embodiment, the baffle element is a movable (i.e., dynamic) element—in this embodiment, the baffle element is positioned to block the “gap” referred above during normal operation of the fluid treatment system. When the cleaning system is extended to the distal tip of the radiation source assemblies, the baffle element is moved to allow relatively unrestricted movement of fluid through the “gap” referred to above—this facilitates removal of the fouling materials after they have been pushed off the end of the radiation source assemblies.

In another of its aspects, the present invention relates to a cleaning apparatus for a radiation source assembly in the fluid treatment system. The cleaning apparatus utilizes a rodless cylinder having disposed therein an elongate motive element coupled to a driving element. The slidable element is disposed on the exterior of the rodless cylinder and is magnetically coupled to the driving element. By arranging the elongate motive element to have a longitudinal axis that is substantially parallel and non-coaxial with the longitudinal axis of the housing of the rodless cylinder, the above-mentioned problem associated with implementation of the mechanical drive embodiment of the Pearcey cleaning system is overcome.

While it is preferred to combine the present cleaning apparatus and fluid treatment system, this is not required. Thus, for example, it is possible to implement the present fluid treatment system with a different cleaning apparatus. Alternatively, it is possible to implement the present cleaning apparatus on a different fluid treatment system.

### BRIEF DESCRIPTION OF THE DRAWINGS

Embodiments of the present invention will be described with reference to the accompanying drawings, wherein like reference numerals denote like parts, and in which:

FIG. 1 illustrates a perspective view, in partial cross-section, of a preferred embodiment of the present fluid treatment system;

FIG. 2 illustrates a side view of a fluid treatment system illustrated in FIG. 1 prior to removing of fouling materials from the radiation source assemblies;

FIGS. 3-5 illustrate, in a sequential manner, removal of fouling materials from the exterior of the radiation source assemblies shown in FIG. 2;

FIG. 6 illustrates a perspective view of the radiation source module used in the fluid treatment system illustrated in FIGS. 1-5;

FIG. 7 illustrates a side view of a preferred embodiment of the driving mechanism for the cleaning apparatus used in the fluid treatment system of FIGS. 1-6;

FIG. 8 illustrates a cross-sectional view of the drive mechanism illustrated in FIG. 7;

FIG. 9 illustrates a perspective view (partially cut away) of a fluid treatment system employ a movable baffle during regular operation of the fluid treatment system;

FIG. 10 illustrates a perspective view (partially cut away) of a fluid treatment system employ a movable baffle during actuation of the cleaning system.

### DETAILED DESCRIPTION OF THE PREFERRED EMBODIMENTS

In one of its aspects, the present invention relates to a cleaning apparatus. Preferred embodiments of the cleaning system may include any one or a combination of any two or more of any of the following features:
the motive element may comprise an elongate mechanical drive disposed within the rodless cylinder;
the mechanical drive may comprise an elongate rotatable member engaged with the driving element;
the driving element may comprise a coupling element coupled to the mechanical drive;
the coupling element may comprise an elongate passageway through which the elongate mechanical drive passes;
the elongate passageway may have a longitudinal axis that is substantially coaxial with the second longitudinal axis;
the mechanical drive may comprise an elongate rotatable screw element in engagement with the driving element;
the driving element may be axially slidable within the elongate housing;
the driving element may comprise a plurality of driving magnets and the slidable member comprises a plurality of driven magnets;
the rodless cylinder may be submersible in a fluid to be treated;
the cleaning carriage may comprise a plurality of cleaning rings;
the cleaning rings may be annular;
the plurality of cleaning rings may be arranged in parallel with respect to one another;
the cleaning carriage may comprise at least one pair of cleaning rings opposed with respect to the rodless cylinder;
the cleaning carriage may comprise a first plurality of cleaning rings and a second plurality of cleaning rings which are opposed with respect to the rodless cylinder;
the first plurality of cleaning rings and the second plurality of cleaning rings may contain the same number of cleaning rings;
the cleaning carriage may comprise a plurality of cleaning rings disposed in a substantially annular relationship with respect to the rodless cylinder;
each cleaning ring may comprise a scraper element for scraping at least a portion of undesired materials from the exterior of the radiation source assembly when the slidable member is translated along the rodless cylinder;
each cleaning ring may comprise a wiper element for wiping at least a portion of undesired materials from the exterior of the radiation source assembly when the slidable member is translated along the rodless cylinder;
each cleaning ring may comprise a seal for sealing engagement with the portion of the exterior of the radiation source assembly, the seal removing at least a portion of undesired materials from the exterior of the radiation source assembly when the slidable member is translated along the rodless cylinder;
the cleaning ring may comprise a chamber for surrounding a portion of the exterior of the radiation source assembly; and/or
the cleaning ring may further comprise an inlet for introduction of a cleaning solution to the chamber.

The cleaning apparatus may be incorporated in a radiation source module that may include any one, or a combination of any two or more, of the following features:
the module may further comprise means to position the radiation source module in the fluid treatment system;
the at least one radiation source assembly may be in sealing engagement with the first support member;
the frame may further comprise a second support member opposed to and laterally spaced from the first support member, the at least one radiation source assembly disposed between each of the first support member and the second support member;
the frame may further comprise a third support member interconnecting the first support member and the second support member;
the frame may further comprise a power supply for controlling the radiation source;
the first support member may comprise a hollow passageway for receiving a lead wire for conveying electricity to the radiation source;
the radiation source assembly may comprise a protective sleeve surrounding the radiation source;
the protective sleeve may comprise a quartz sleeve;
the protective sleeve may have an open end in sealed engagement with an opening in the first support member and a closed end supported by the second support member; and/or
the open end may be sealed to prevent fluid ingress into the module.

The radiation source module may be incorporated in a fluid treatment system that may include any one or a combination of any two or more any of the following features:
the fluid treatment zone may be comprised in an open channel for receiving the flow of fluid;
the fluid treatment zone may be comprised in a closed channel for receiving the flow of fluid;
the at least one radiation source assembly may be elongate and may have a longitudinal axis disposed traverse to the direction of fluid flow through the fluid treatment zone;
the at least one radiation source assembly may be elongate and may have a longitudinal axis disposed substantially parallel to the direction of fluid flow through the fluid treatment zone;
the at least one radiation source assembly may be elongate and may have a longitudinal axis disposed orthogonal to the direction of fluid flow through the fluid treatment zone; and/or
the at least one radiation source assembly may be elongate and may be disposed substantially vertically in the fluid treatment zone.

In another of its aspects, the present invention relates to a fluid treatment system. Preferred embodiments of the fluid treatment system may include any one, or a combination of any two or more, of the following features:
the longitudinal axis of the at least one elongate radiation source assembly may be disposed orthogonal to a direction of fluid flow through the fluid treatment zone;
the at least one elongate radiation source assembly may be disposed substantially vertically with respect to a fluid flow through the fluid treatment zone;
the fluid treatment zone may be comprised in an open channel for receiving the flow of fluid;
the open channel may comprise a floor;
the gap may be above the floor;
the at least one elongate radiation source assembly may be disposed in the fluid treatment such that a proximal portion thereof is above the flow of fluid and the distal end thereof is within the flow of fluid;
in the retracted position, the cleaning apparatus may be out of the flow of fluid;
in the retracted position, the cleaning apparatus may be immersed in the flow of fluid;
in the extended position, the cleaning apparatus may be within 12 inches of the distal end of the at least one radiation source assembly;
in the extended position, the cleaning apparatus may be within 10 inches of a distal end of the at least one radiation source assembly;
in the extended position, the cleaning apparatus may be within 8 inches of a distal end of the at least one radiation source assembly;
in the extended position, the cleaning apparatus may be within 6 inches of a distal end of the at least one radiation source assembly;
in the extended position, the cleaning apparatus may be within 4 inches of a distal end of the at least one radiation source assembly;
in the extended position, the cleaning apparatus may be within 2 inches of a distal end of the at least one radiation source assembly;
the distal end of the at least one elongate radiation source assembly may be spaced from the surface of the fluid treatment zone at a distance of up to about 12 inches;
the distal end of the at least one elongate radiation source assembly may be spaced from the surface of the fluid treatment zone at a distance of from about 0.5 inches about 12 inches;
the distal end of the at least one elongate radiation source assembly may be spaced from the surface of the fluid treatment zone at a distance of from about 0.5 inches about 10 inches;
the distal end of the at least one elongate radiation source assembly may be spaced from the surface of the fluid treatment zone at a distance of from about 1 inch about 10 inches;
the distal end of the at least one elongate radiation source assembly may be spaced from the surface of the fluid treatment zone at a distance of from about 1 inch about 8 inches;
the distal end of the at least one elongate radiation source assembly may be spaced from the surface of the fluid treatment zone at a distance of from about 1 inch about 6 inches;
the distal end of the at least one elongate radiation source assembly may be spaced from the surface of the fluid treatment zone at a distance of from about 1 inch about 4 inches;
the distal end of the at least one elongate radiation source assembly may be spaced from the surface of the fluid treatment zone at a distance of from about 1 inch about 2 inches;
a single cleaning element may be in contact with the exterior surface of one elongate radiation source assembly;
two or more cleaning elements may be in contact with the exterior surface of one elongate radiation source assembly;
a plurality of radiation source assemblies may be used in the fluid treatment system;
a single cleaning element may be in contact with the exterior surface of each elongate radiation source assembly;
two or more cleaning elements may be in contact with the exterior surface of each elongate radiation source assembly;
the cleaning element may comprise a wiper element;
the cleaning element may comprise a scraper element;
the cleaning element may comprise an annular element that surrounds a portion of the exterior surface of the at least one radiation source assembly;
the cleaning element may comprise a brush element
the cleaning element may comprise a cleaning ring having a chamber for surrounding a portion of the exterior of the radiation source assembly;
the cleaning ring may further comprise an inlet for introduction of a cleaning solution to the chamber;
the cleaning apparatus may be the cleaning apparatus described above (including any one or a combination of any two or more of the following features of preferred embodiments described above for the cleaning apparatus);
the at least one radiation source assembly may be the radiation source module described above (including any one or a combination of any two or more any of the following features of preferred embodiments of described above for the radiation source module); and/or
the fluid treatment system may further comprise a baffle element;
the baffle element may comprise a baffle plate that substantially obstructs a portion of the fluid treatment zone corresponding to the gap;
the baffle plate may have a height that corresponds to a height of the gap;
the baffle plate may have a height that is greater than a height of the gap;
the baffle plate may be secured with respect to a surface of the fluid treatment zone;
the baffle plate may be movable with respect to a surface of the fluid treatment zone;
the baffle plate may be movable with respect to a surface of the fluid treatment zone between an extended position and a retracted position;
the extended position of the baffle plate may correspond substantially to the retracted position of the cleaning system;
the retracted position of the baffle plate may correspond substantially to the extended position of the cleaning system; and/or
the extended position of the baffle plate may correspond substantially to the retracted position of the cleaning system and the retracted position of the baffle plate may correspond substantially to the extended position of the cleaning system.

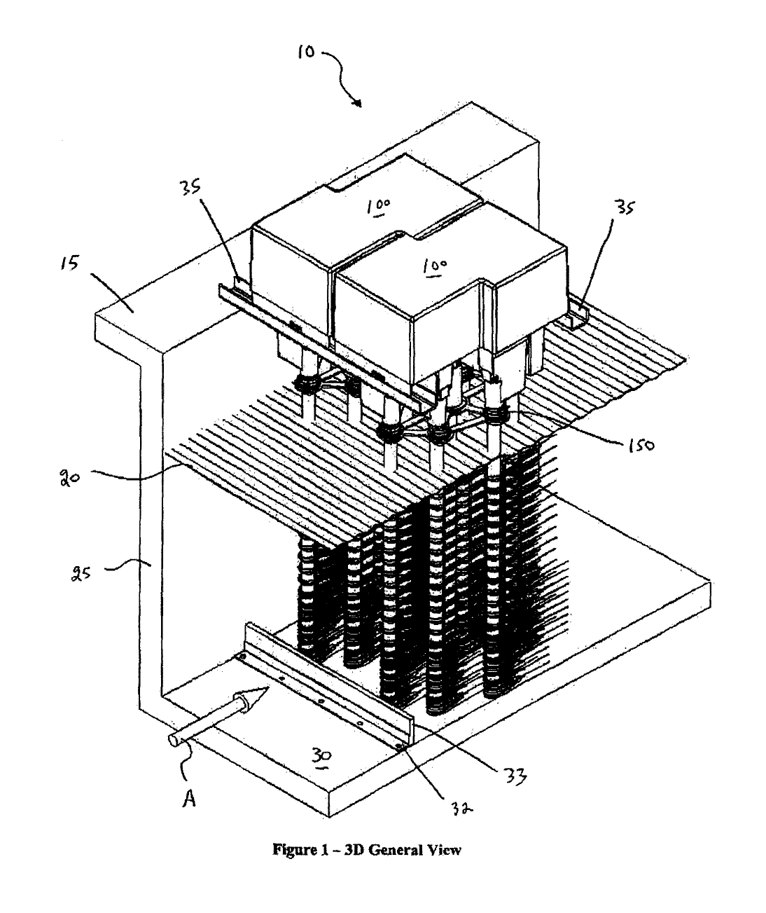

With reference to FIGS. 1-6, there is illustrated a fluid treatment system 10. Fluid treatment system 10 comprises an open channel 15 which receives a flow of fluid 20. In the illustrated embodiment, flow of fluid 20 is gravity fed in the direction of arrow A in open channel 15. Open channel 15 comprises a pair of side walls 25 (only one side wall 25 is shown in FIG. 1 for clarity) and a floor 30. Mounted to floor 30 is a baffle element 32 having an upstanding baffle plate 33 that spans the distance between pair of side walls 25. Baffle element 32 functions as described above.

Spanning open channel 15 are a pair of module support frames 35 which support a pair of radiation source modules 100. The radiation source modules 100 contain a series of radiation source assemblies 110 which are supported at a proximal portion 115 of radiation source module 100. A cleaning apparatus 150 is engaged with the exterior of each radiation source assemblies 110. Cleaning apparatus 150 is connected to a drive element 170 which drives the wiping mechanism engaged to the exterior surface of each radiation source assembly 110 in both radiation source module 100. Of course, it is possible to have an independent drive element for each radiation source module 100.

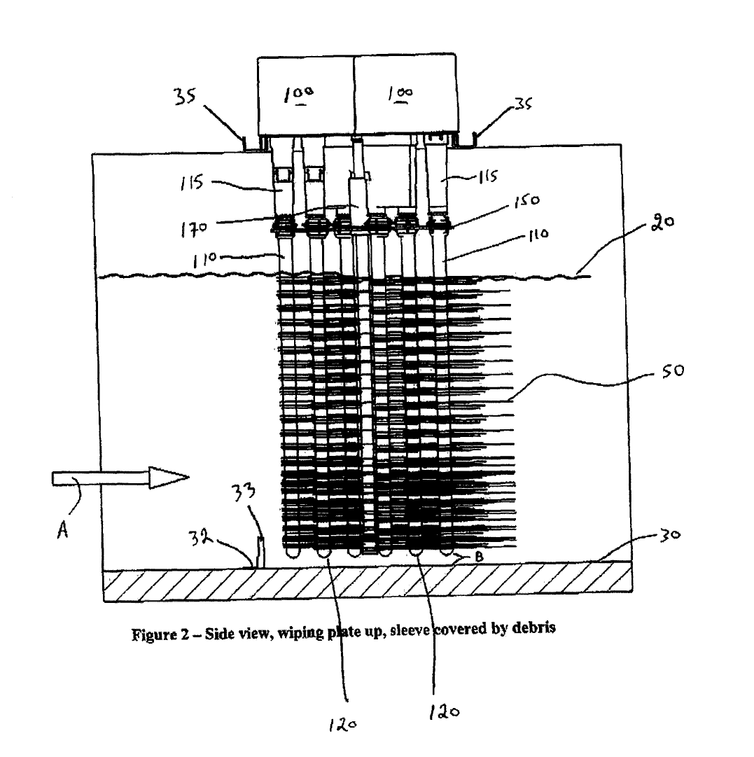

As shown particularly in FIG. 2, the distal portion 120 of radiation source assemblies 110 are disposed at a distance B above floor 30 of open channel 15. This creates a so-called gap (a fluid flow-through zone in the specifically illustrated embodiment) that will be described in more detail below. In the illustrated embodiment baffle element 32 has a height that is greater than distance B.

As also illustrated in FIG. 2, during normal use of fluid treatment 10, string-like debris 50 will catch or otherwise snag on the exterior surfaces of radiation source assemblies 110.

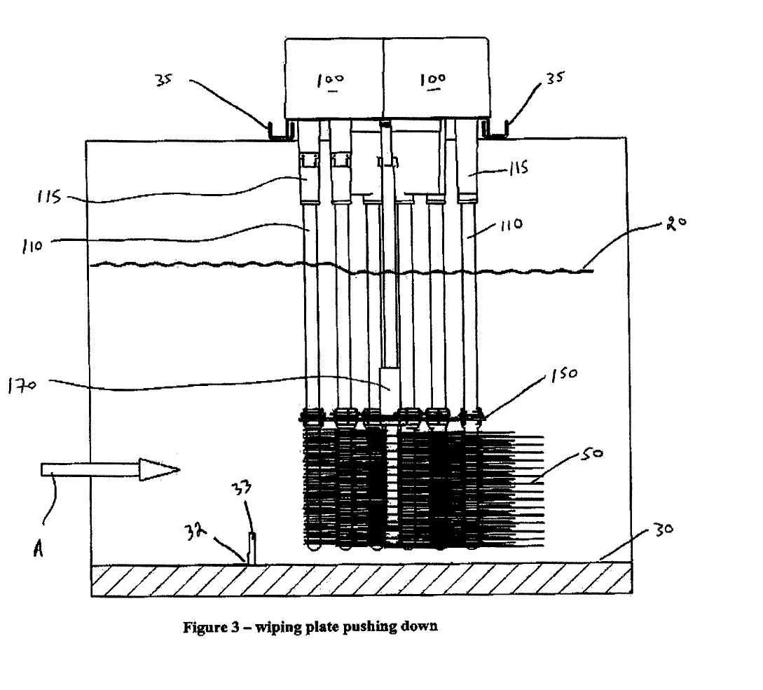

When it is desired to remove debris 50 from the exterior surfaces radiation source assemblies 110, drive element 170 is actuated to translate cleaning apparatus 150 toward the distal region 120 of radiation source assemblies 110. This has the effect of moving the debris toward the gap defined by having the distal portion of radiation source assemblies 110 above floor 30 of open channel 15. This is illustrated sequentially in FIGS. 3-5 and culminates with debris 50 being flushed away from radiation source modules 100 by the flowing fluid. As discussed above, baffle element 32 functions to obviate or mitigate the effects of shortcuiting that otherwise might occur by virtue of a layer fluid flow through the gap corresponding to distance B.

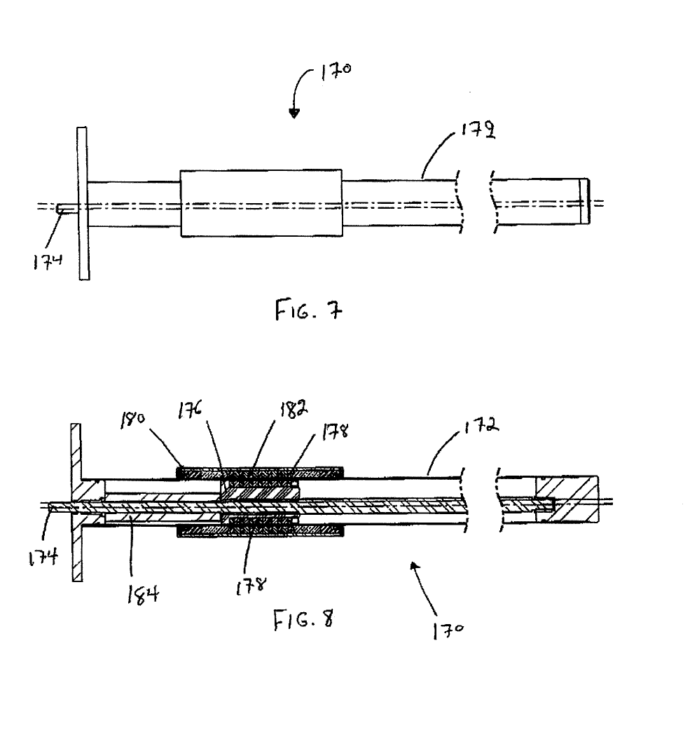

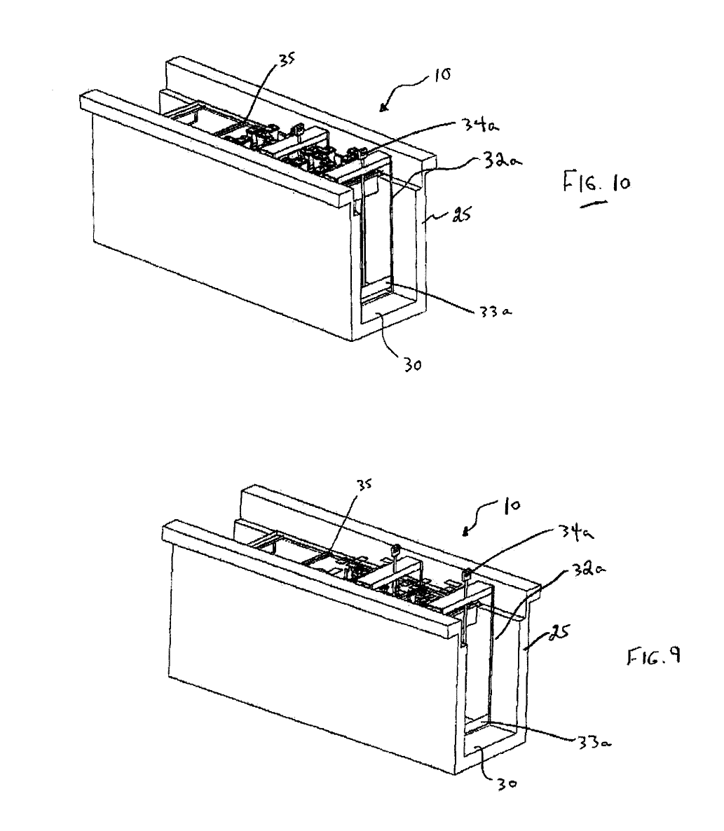

With reference to FIGS. 9 and 10, there is illustrate an alternative to using fixed baffle element 32 illustrated in FIGS. 1-6 (like numerals denote like parts between the embodiment illustrated in FIGS. 1-6 and that illustrated in FIGS. 9-10). Although not specially shown (for clarity), the distal tips of the radiation source assemblies are disposed above floor 30 to define a gap corresponding the distance (B) between the distal tips of the radiation source assemblies and floor 30.

More specifically, there is illustrated a dynamic baffle element 32a comprising a movable baffle plate 33a that is coupled to a handle 34a. As discussed below, dynamic baffle element 32a is configured to have a guillotine-type action.

During normal operation of fluid treatment system 10, handle 34a is fully extended to toward floor to position the bottom of baffle plate 33a in a substantially abutting relationship with floor 30—this is illustrated in FIG. 9. In this configuration, and as discussed above, baffle plate 33a functions to obviate or mitigate the effects of short-circuiting that otherwise might occur by virtue of a layer of fluid flow through the gap corresponding to distance B.

When it is desired to remove fouling materials for the exterior of the radiation source assemblies, the cleaning apparatus is actuated as described above with reference to FIGS. 3-5. As the cleaning apparatus approaches the fully extended position (FIG. 4), handle 34a is retracted to lift baffle plate 33a a distance corresponding to at least to the gap corresponding to distance B—this is illustrated in FIG. 10. Of course it is possible to retract handle 34a so that baffle plate 33a is fully withdrawn from the fluid being treated (this specific embodiment is not shown). The actuation of handle 34a may be manual, semi-automatic (e.g., one switch for concurrent operation of all handles 34a) or fully automatic. After the fouling materials are carried away (FIG. 5), handle 34a is extended to position baffle plate 33a as shown in FIG. 9.

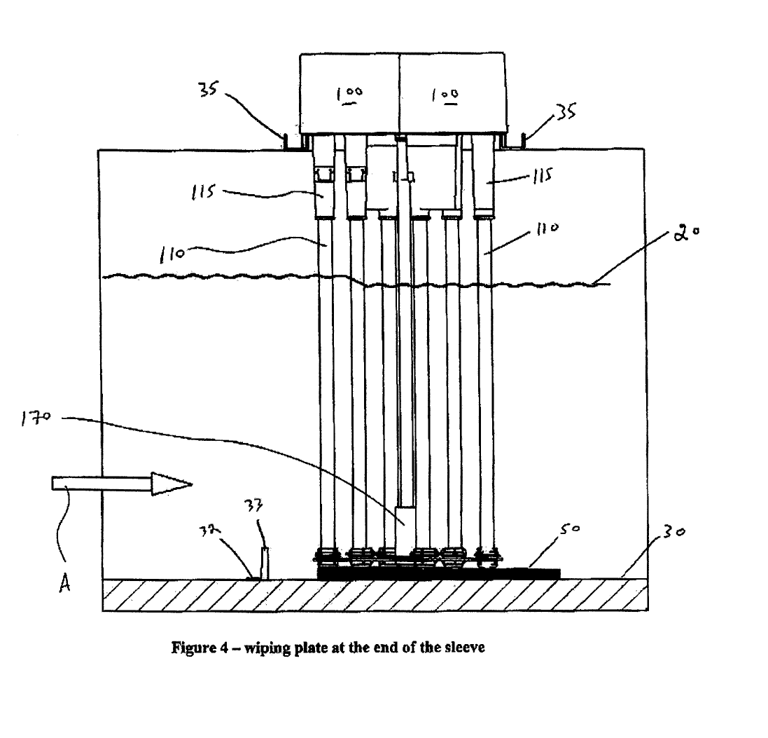

With reference to FIG. 6, there is shown a perspective view of radiation source module 100. Further details on this preferred embodiment of radiation source module 100 are set out in co-pending provisional U.S. patent application Ser. No. 61/193,686, filed Dec. 16, 2008.

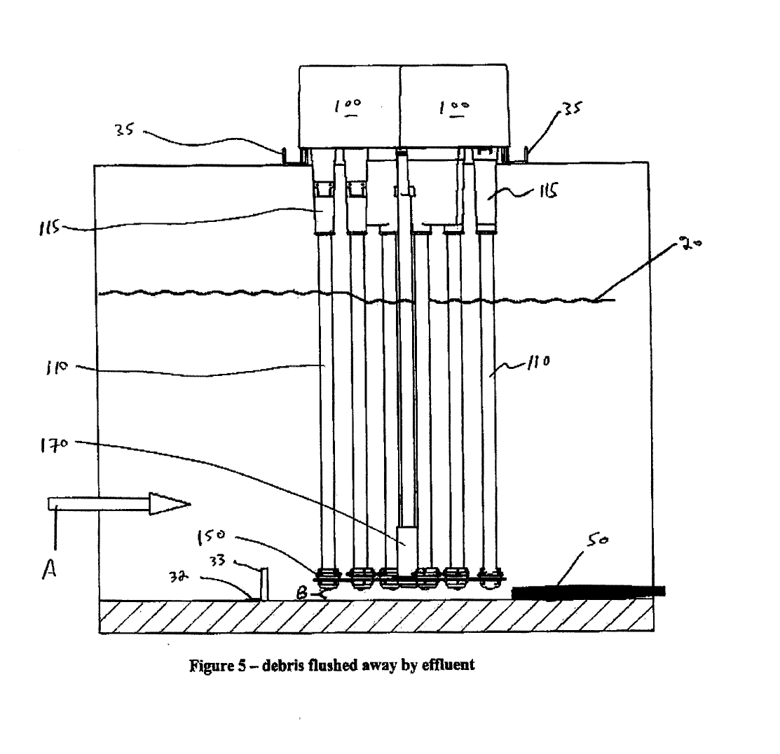

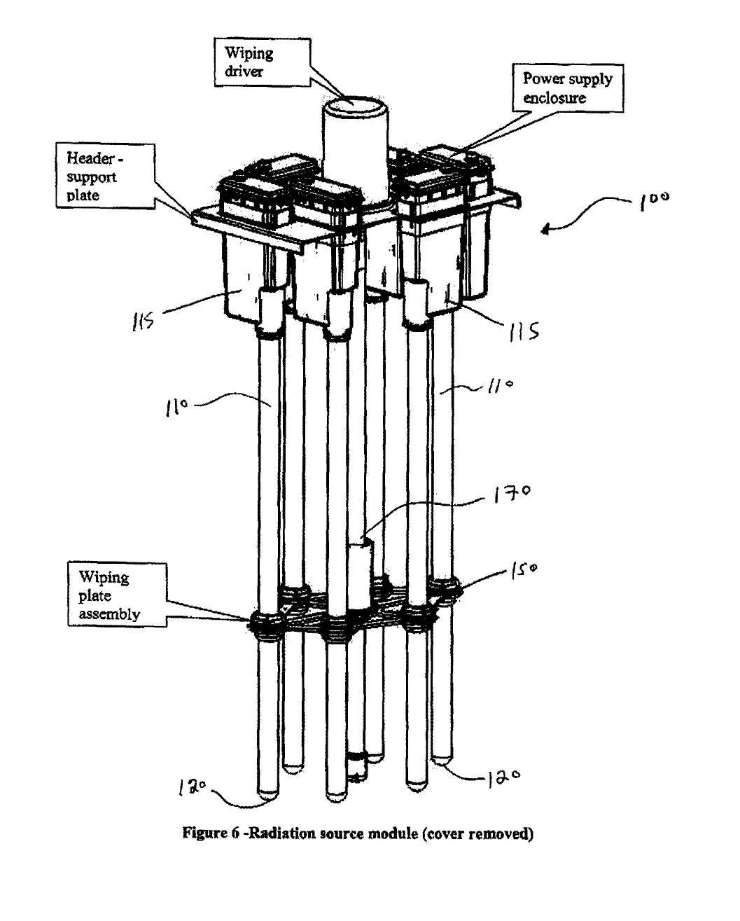

A preferred embodiment of drive element 170 will be described with reference to FIGS. 7 and 8.

Thus, drive element 170 comprises an elongate housing 172 in which is disposed a drive screw 174. The coupling nut 176 is in engagement with drive screw 174—in this illustrated embodiment, the longitudinal axis of the aperture in coupling nut 176 is coaxial with respect to the longitudinal axis of drive screw 174. Coupling nut 176 carries a series of permanent magnets 178. The combination of coupling nut 176 and permanent magnets 178 define a drive member which can be translated along the interior of the elongate housing 172.

Disposed on the exterior of elongate housing 172 is a slidable member 180 having disposed therein a series of permanent magnets 182. Permanent magnets 182 are magnetically coupled to permanent magnets 178 which form part of the drive member inside elongate housing 172. The cleaning carriage (150 in the embodiment illustrated in FIGS. 1-6) is coupled to slidable member 180. The details of this coupling are conventional. See, for example, FIGS. 1-6 and/or Pearcey.

As shown, elongate housing 172 has a longitudinal axis that is parallel to the longitudinal axis of each of the drive screw 174 and coupling nut 176. As further shown, the longitudinal axis of elongate housing 172 is in a non-coaxial relationship with the longitudinal axis of each of drive screw 174 and coupling nut 176.

Thus, in the illustrated preferred embodiment, the centre axis of screw drive 174 is positioned in a slight offset to the axis of elongate housing 172. Further, the axis of the threaded hole in coupling nut 176 is positioned slightly offset with respect to the axis of permanent magnets 178. The combination of offset screw drive 174 and offset coupling nut 176 is such that the axis of permanent magnets 178 is coaxial with the longitudinal axis of elongate housing 172.

Elongate housing 172 also includes a stop 184 for limiting movement of slidable member 180 toward the proximal portion of drive element 170. A proximal portion of screw drive 174 is connected to a suitable electric motor (or the like) (not shown for clarity).

When it is desired to actuate drive element 170, screw drive 174 is rotated in one direction which will result in movement of slidable member 180 from a position near the proximal end of drive element 170 to an extended position which is near the distal portion of drive element 170. The movement of slidable member 180 in this fashion causes movement of whatever cleaning element is attached to slidable member 180—see FIGS. 1-6 above and/or Pearcey.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. For example, the fixed baffle element illustrated in FIGS. 1-5 may be modified to be hinged or otherwise movable between an in use position and a retracted position. Also, while the illustrated embodiments depict a single baffle element, it is possible to use multiple baffle elements, for example in a serial arrangement with each baffle element disposed upstream of a bank of radiation source assemblies in the fluid treatment zone of the fluid treatment system. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A cleaning apparatus for a radiation source assembly in a fluid treatment system, the cleaning system comprising:
a cleaning carriage comprising at least one cleaning element for contact with at least a portion of the exterior of the radiation source assembly;
a rodless cylinder comprising an elongate housing having a first longitudinal axis;
a slidable element disposed on an exterior surface of the elongate housing, the slidable element being: (i) coupled to the cleaning carriage, and (ii) magnetically coupled to a driving element disposed within the elongate housing; and
an elongate motive element coupled to the driving element, the elongate motive element having a second longitudinal axis that is oriented in a substantially parallel, non-coaxial relationship with respect to the first longitudinal axis.

2. The cleaning apparatus defined in claim 1, wherein the motive element comprises an elongate mechanical drive disposed within the rodless cylinder.

3. The cleaning apparatus defined in claim 2, wherein the mechanical drive comprises an elongate rotatable member engaged with the driving element.

4. The cleaning apparatus defined in claim 2, wherein the driving element comprises a coupling element coupled to the mechanical drive.

5. The cleaning apparatus defined in claim 4, wherein the coupling element comprises an elongate passageway through which the elongate mechanical drive passes.

6. The cleaning apparatus defined in claim 5, wherein the elongate passageway has a longitudinal axis that is substantially coaxial with the second longitudinal axis.

7. The cleaning apparatus defined in claim 2, wherein the mechanical drive comprises an elongate rotatable screw element in engagement with the driving element.

8. The cleaning apparatus defined in claim 1, wherein the driving element is axially slidable within the elongate housing.

9. The cleaning apparatus defined in claim 8, wherein the driving element comprises a plurality of driving magnets and the slidable member comprises a plurality of driven magnets.

10. The cleaning apparatus defined in claim 1, wherein the rodless cylinder is submersible in a fluid to be treated.

11. The cleaning apparatus defined in claim 1, wherein the cleaning carriage comprises a plurality of cleaning rings.

12. The cleaning apparatus defined in claim 11, wherein the cleaning rings are annular.

13. The cleaning apparatus defined in claim 12, wherein the plurality of cleaning rings are arranged in parallel with respect to one another.

14. The cleaning apparatus defined in claim 1, wherein the cleaning carriage comprises at least one pair of cleaning rings opposed with respect to the rodless cylinder.

15. The cleaning apparatus defined in claim 1, wherein the cleaning carriage comprises a first plurality of cleaning rings and a second plurality of cleaning rings which are opposed with respect to the rodless cylinder.

16. The cleaning apparatus defined in 15, wherein the first plurality of cleaning rings and the second plurality of cleaning rings contain the same number of cleaning rings.

17. The cleaning apparatus defined in claim 1, wherein the cleaning carriage comprises a plurality of cleaning rings disposed in a substantially annular relationship with respect to the rodless cylinder.

18. The cleaning apparatus defined in claim 1, wherein each cleaning ring comprises a scraper element for scraping at least a portion of undesired materials from the exterior of the radiation source assembly when the slidable member is translated along the rodless cylinder.

19. The cleaning apparatus defined in claim 1, wherein each cleaning ring comprises a wiper element for wiping at least a portion of undesired materials from the exterior of the radiation source assembly when the slidable member is translated along the rodless cylinder.

20. The cleaning apparatus defined in claim 1, wherein each cleaning ring comprises a seal for sealing engagement with the portion of the exterior of the radiation source assembly, the seal removing at least a portion of undesired materials from the exterior of the radiation source assembly when the slidable member is translated along the rodless cylinder.

21. The cleaning apparatus defined in claim 1, wherein the cleaning ring comprises a chamber for surrounding a portion of the exterior of the radiation source assembly.

22. The cleaning apparatus defined in claim 21, wherein the cleaning ring further comprises an inlet for introduction of a cleaning solution to the chamber.

23. A radiation source module for use in a fluid treatment system, the module comprising:
a frame having a first support member;
at least one radiation source assembly extending from the first support member, the at least one radiation source assembly comprising a radiation source; and
cleaning apparatus defined in claim 1, the cleaning element of the cleaning carriage being in contact with at least a portion of an exterior of the at least one radiation source assembly.

24. (canceled)

25. (canceled)

26. (canceled)

27. (canceled)

28. (canceled)

29. (canceled)

30. (canceled)

31. (canceled)

32. (canceled)

33. (canceled)

34. A fluid treatment system comprising a fluid treatment zone for receiving a flow of fluid and at least one radiation source module defined in claim 33, wherein the at least one radiation source module is configured such that the one radiation source assembly is disposed in the fluid treatment zone.

35. (canceled)

36. (canceled)

37. (canceled)

38. (canceled)

39. (canceled)

40. (canceled)

41. A fluid treatment system comprising:
a fluid treatment zone for receiving a flow of fluid;
at least one elongate radiation source assembly disposed in the fluid treatment zone, the elongate radiation source assembly having a longitudinal axis disposed transverse to a direction of fluid flow through the fluid treatment zone, a distal end of the at least one elongate radiation source assembly being spaced from a surface of the fluid treatment zone to define a gap;
a cleaning apparatus having at least one cleaning element in contact with an exterior surface of the at least one elongate radiation source assembly; and
a motive element coupled to the cleaning system, the motive element operable (e.g., manual, semi-automatic or automatic) to move the cleaning system between a retracted position and an extended position, wherein movement of the cleaning system from the retracted position to the extended position cause debris contacting the at least one elongate radiation source assembly to be pushed into the gap.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. A method removing fouling material from an exterior surface of at least one radiation source assembly in a fluid treatment system as defined in claim 41 comprising the steps of:
translating the cleaning apparatus from the retracted position toward the extended position to cause fouling material disposed on the exterior surface of the at least one radiation source assembly to be translated toward the distal end; and
further translating the cleaning apparatus to the extended position to cause fouling material to be move past the distal end of the at least one radiation source assembly into the gap.
